(19) United States
(12) Patent Application Publication
(10) Pub. No.: US 2004/0223449 A1
(43) Pub. Date: Nov. 11, 2004

(54) Mode detection for OFDM signals

(76) Inventors: Yih-Ming Tsuie, Hsinchu (TW); Hsiao-Chen Liu, Tainan (TW)

Correspondence Address: BIRCH STEWART KOLASCH & BIRCH, PO BOX 747, FALLS CHURCH, VA, 22040-0747, US

(21) Appl. No.: 10/431,518

(22) Filed: May 8, 2003

(51) Int. Cl. H04J 11/00

(52) U.S. Cl. 370/204

(57) ABSTRACT

A method of mode detection for an OFDM signal. The method comprises the steps of a) selecting one of the desired symbol lengths, b) selecting one of the threshold values, c) generating a correlation power signal of the OFDM signal using the selected desired symbol length, d) detecting edges of the correlation power signal using the selected threshold value, e) when the edge detection succeeds, determining the transmission mode and guard interval length by the detected edges, and f) when the edge detection fails, determining whether all the threshold values have been selected, if so, selecting another one of the desired symbol lengths and repeating steps b, c, d, e and f, otherwise, selecting another one of the threshold values and repeating steps c, d, e and f.

### BACKGROUND OF THE INVENTION

1. Field of the Invention

The present invention relates to an OFDM receiver and particularly to a method of mode detection for OFDM signals in a DVB-T receiver.

2. Description of the Prior Art

OFDM is a multi-channel modulation system employing Frequency Division Multiplexing (FDM) of orthogonal sub-carriers, each modulated by a low bit-rate digital stream.

In older multi-channel systems using FDM, the total available bandwidth is divided into N non-overlapping frequency sub-channels. Each sub-channel is modulated with a separate symbol stream and the N sub-channels are frequency multiplexed. Even though the prevention of spectral overlapping of sub-carriers reduces (or eliminates) Inter-channel Interference, this leads to an inefficient use of spectrum. The guard bands on either side of each sub-channel waste bandwidth. To overcome the problem of wasted bandwidth, alternatively, N overlapping (but orthogonal) sub-carriers, each carrying a baud rate of 1/T and spaced 1/T apart can be used. Because of the selected frequency spacing, all the sub-carriers are mathematically orthogonal to each other. This permits the proper demodulation of the symbol streams without requiring non-overlapping spectra. Another way of specifying the sub-carrier orthogonality is to require that each sub-carrier have an exact integer number of cycles in the interval T. The modulation of these orthogonal sub-carriers can be represented as an Inverse Fourier Transform. Alternatively, a DFT operation followed by low-pass filtering can generate the OFDM signal. It must be noted that OFDM can be used either as a modulation or multiplexing technique.

The use of Discrete Fourier Transform (DFT) in the parallel transmission of data using Frequency Division Multiplexing was investigated in 1971 by Weinstein and Ebert. In a data sequence d₀, d₂, . . . , d_{N-1}, where each dₙ is a complex symbol (the data sequence can be the output of a complex digital modulator, such as QAM, PSK etc), when performing an IDFT on the sequence 2dn (the factor 2 is used purely for scaling purposes), N complex numbers Sm (m=0,1 . . . , N−1) result, as:

$$\begin{matrix}{S}_{m} = 2 {\sum }_{n = 0}^{N - 1} {d}_{n} exp ( j 2 π \frac{n m}{N} ) = 2 {\sum }_{n = 0}^{N - 1} {d}_{n} exp ( j 2 π {f}_{n} {t}_{m} ) & ( 2.1 ) \\ [ m = 0 , 1 , … N - 1 ] & \\ Where , & \\ \begin{matrix}{f}_{n} = \frac{n}{{NT}_{s}} & and & t = {mT}_{s}\end{matrix} & ( 2.2 )\end{matrix}$$

Where, Tₛ represents the symbol interval of the original symbols. Passing the real part of the symbol sequence represented by equation (2.1) through a low-pass filter with each symbol separated by a duration of Tₛ seconds, yields the signal,

$$\begin{matrix}y ( t ) = 2 Re \{ {\sum }_{n = 0}^{N - 1} {d}_{n} exp ( j 2 π \frac{n}{T} t ) \} , & for 0 ≦ t ≦ T\end{matrix} \qquad ( 2.3 )$$

Where T is defined as NTₛ. The signal y(represents the baseband version of the OFDM signal.

It can be noted from (2.3) that the length of the OFDM signal is T, the spacing between the carriers is equal to 1/T, the OFDM symbol-rate is N times the original baud rate, there are N orthogonal sub-carriers in the system, and the signal defined in equation (2.3) is the basic OFDM symbol.

One of the main advantages of OFDM is its effectiveness against the multi-path delay spread frequently encountered in mobile communication channels. The reduction of the symbol rate by N times results in a proportional reduction of the relative multi-path delay spread, relative to the symbol time. To completely eliminate even the very small ISI that results, a guard time is introduced for each OFDM symbol. The guard time chosen must be larger than the expected delay spread, such that multi-path components from one symbol cannot interfere with the next symbol. Leaving the guard time empty may lead to inter-carrier interference (ICI), since the carriers are no longer orthogonal to each other. To avoid such crosstalk between sub-carriers, the OFDM symbol is cyclically extended during the guard time. This ensures that the delayed replicas of the OFDM symbols always have an integer number of cycles within the FFT interval as long as the multi-path delay spread is less than the guard time.

If the ODFM symbol is generated using equation (2.3), the power spectral density of this signal is similar to that shown in FIG. 1. The sharp-phase transition caused by phase modulation result in very large side-lobes in the PSD and the spectrum falls off rather slowly (according to a sinc function). If the number of sub-carriers increases, the spectrum roll-off is sharper in the beginning, but moves further away at frequencies from the 3-dB cut-off frequency. To overcome this problem of slow spectrum roll-off, a windowing may be used to reduce the side-lobe level. The most commonly used window is the Raised Cosine Window given by:

$$w ( t ) = \{ \begin{matrix}0.5 + 0.5 cos ( π + π t / ( β {T}_{r} ) ) , & 0 \leq t \leq β {T}_{r} \\ 1.0 , & β {T}_{s} \leq t \leq {T}_{r} \\ 0.5 + 0.5 cos ( ( t - {T}_{r} ) π / β {T}_{r} ) ) , & {T}_{s} \leq t \leq ( 1 + β ) {T}_{r}\end{matrix}$$

Here Tᵣ is the symbol interval chosen to be shorter than the actual OFDM symbol duration, since the symbols are allowed to partially overlap in the roll-off region of the raised cosine window. Incorporating the windowing effect, the OFDM symbol can now be represented as:

$$y ( t ) = 2 Re \{ w ( t ) {\sum }_{n = 0}^{N - 1} {d}_{n} exp ( j 2 π \frac{n}{T} t ) \} , \qquad for 0 ≦ t ≦ T$$

It must be noted that filtering can also be used as a substitute for windowing, for tailoring the spectrum roll-off. Windowing, though, is preferred to filtering because it can be carefully controlled. With filtering, rippling effects in the roll-off region of the OFDM symbol must be avoided. Rippling causes distortions in the OFDM symbol, which directly leads to less-delay spread tolerance.

Based on the previous discussions, the method for generating an ODFM symbol is as follows.

First, the N input complex symbols are padded with zeros to get Nₛ symbols to calculate the IFFT. The output of the IFFT is the basic OFDM symbol.

Based on the delay spread of the multi-path channel, a specific guard-time must be chosen (e.g. T_{g}). A number of samples corresponding to this guard time must be taken from the beginning of the OFDM symbol and appended to the end of the symbol. Likewise, the same number of samples must be taken from the end of the OFDM symbol and inserted at the beginning.

The OFDM symbol must be multiplied by the raised cosine window to remove the power of the out-of-band sub-carriers.

The windowed OFDM symbol is then added to the output of the previous OFDM symbol with a delay of Tᵣ, so that there is an overlap region of βTᵣ between each symbol.

OFDM system design, as in any other system design, involves tradeoff and conflicting requirements. The following are the most important design parameters of an OFDM system and may form part of a general OFDM system specification: Bit Rate required for the system, Bandwidth available, BER requirements (Power efficiency) and RMS delay spread of the channel.

Guard Time

Guard time in an OFDM system usually results in an SNR loss in an OFDM system, since it carries no information. The choice of the guard time is straightforward once the multi-path delay spread is known. As a rule of thumb, the guard time must be at least 2-4 times the RMS delay spread of the multi-path channel. Further, higher-order modulation schemes (like 32 or 64 QAM) are more sensitive to ISI and ICI than simple schemes like QPSK. This factor must also be taken into account when determining the guard-time.

Symbol Duration

To minimize SNR loss due to guard time, symbol duration must be set much higher than guard time. An increase in symbol time, however, implies a corresponding increase in the number of sub-carriers and thus an increase in the system complexity. A practical design choice for symbol time requires at least five times the guard time, which leads to an acceptable SNR loss.

Number of Sub-carriers

Once the symbol duration is determined, the number of sub-carriers required can be determined by first calculating the sub-carrier spacing buy simply inverting the symbol time (less the guard period). The number of sub-carriers is the available bandwidth divided by the sub-carrier spacing.

Modulation and Coding Choices

The first step in selecting coding and modulation techniques is to determine the number of bits carried by an OFDM symbol. Then, a suitable combination of modulation and coding techniques can be selected to fit the input data rate into the OFDM symbols and, at the same time, satisfy the bit-error rate requirements. Selection of modulation and coding techniques is now simplified, since each channel is assumed to be almost AWGN and there is no requirement for consideration of the effects of multi-path delay spread.

OFDM possesses inherent advantages for wireless communications.

As discussed earlier, the increase in the symbol time of the OFDM symbol by N times (N being the number of sub-carriers), leads to a corresponding increase in the effectiveness of OFDM against the ISI caused due to multi-path delay spread. Further, use of the cyclic extension process and proper design can completely eliminate ISI from the system.

In addition to delay variations in the channel, the lack of amplitude flatness in the frequency response of the channel also causes ISI in digital communication systems. A typical example would be twister-pair cable used in telephone lines. These transmission lines handle voice calls and have a poor frequency response with regard to high frequency transmission. In systems that use single-carrier transmission, an equalizer may be required to mitigate the effect of channel distortion. The complexity of the equalizer depends upon the severity of the channel distortion and there are frequently issues such as equalizer non-linearities and error propagation etc. that are problematic.

In OFDM systems, on the other hand, since the bandwidth of each sub-carrier is very small, the amplitude response over this narrow bandwidth will be basically flat (of course, it can be safely assumed that the phase response will be linear over this narrow bandwidth). Even in the case of extreme amplitude distortion, an equalizer of very simple structure will be enough to correct the distortion in each sub-carrier.

The use of sub-carrier modulation improves the flexibility of OFDM to channel fading and distortion makes it possible for the system to transmit at maximum possible capacity using the technique of channel loading. If the transmission channel has a fading notch in a certain frequency range corresponding to a certain sub-carrier, the presence of this notch can be detected using channel estimation schemes, and assuming that the notch does not vary fast enough compared to the symbol duration of the OFDM symbol, it is possible to change (scale down/up) the modulation and coding schemes for this particular sub-carrier (i.e., increase their robustness against noise), so that capacity as a whole is maximized over all the sub-carriers. However, this requires the data from channel-estimation algorithms. In the case of single-carrier systems, nothing can be performed against such fading notches. They must somehow survive the distortion using error correction coding or equalizers.

Impulse noise usually comprises a burst of interference in channels such as the return path HFC (Hybrid-Fiber-Coaxial), twisted-pair and wireless channels affected by atmospheric phenomena such as lightning etc. It is common for the length of the interference waveform to exceed the symbol duration of a typical digital communication system. For example, in a 10 MBPS system, the symbol duration is 0.1 μs, and an impulse noise waveform, lasting for a couple of micro-seconds, can cause a burst of errors that cannot be corrected using normal error-correction coding. Usually complicated Reed-Solomon codes in conjunction with huge interleaves are used to correct this problem. OFDM systems are inherently robust against impulse noise, since the symbol duration of an OFDM signal is much larger than that of the corresponding single-carrier system and thus, it is less likely that impulse noise will cause (even single) symbol errors. Thus, complicated error-control coding and interleaving schemes for handling burst-type errors are not really required for OFDM Systems, and simplify transceiver design.

OFDM is the best environment in which to employ frequency diversity. In fact, in a combination of OFDM and CDMA, called MC-CDMA transmission, frequency diversity is inherently present in the system (i.e., it is freely available). Even though OFDM provides advantages for wireless transmission, it has a few serious disadvantages that must be overcome for this technology to become a success.

Many applications that use OFDM technology have arisen in the last few years. In the following, one such application is described in detail.

Digital Video Broadcasting (DVB) is a standard for broadcasting Digital Television over satellite, cable, and terrestrial (wireless) transmission.

DVB-T is the system specification for the terrestrial broadcast of digital television signals. DVB-T was approved by the DVB Steering Board in December 1995. This work was based on a set of user requirements produced by the Terrestrial Commercial Module of the DVB project. DVB members contributed to the technical development of DVB-T through the DTTV-SA (Digital Terrestrial Television-Systems Aspects) of the Technical Module. The European Projects SPECTRE, STERNE, HD-DIVINE, HDTVT, dTTb, and several other organizations developed system hardware and produced test results that were fed back to DTTV-SA.

As with the other DVB standards, MPEG-2 audio and video coding forms the payload of DVB-T. Other elements of the specification include a transmission scheme based on orthogonal frequency-division multiplexing (OFDM), which allows for the use of either 1705 carriers (usually known as 2k), or 6817 carriers (8k). Concatenated error correction is used. The 2k mode is suitable for single-transmitter operation and for relatively small single-frequency networks with limited transmitter power. The 8k mode can be used both for single-transmitter operation and for large-area single-frequency networks. The guard interval is selectable. Reed-Solomon outer coding and outer convolutional interleaving are also used, as with the other DVB standards, and another error-correction system, using a punctured convolutional code, is added. This second error-correction system, the inner code, can be adjusted (in the amount of overhead) to suit the needs of the service provider. The data carriers in the coded orthogonal frequency-division multiplexing (COFDM) frame can use QPSK and different levels of QAM modulation and code rates to trade bits for ruggedness. Bi-level hierarchical channel coding and modulation can be used, but hierarchical source coding is not used. The latter was deemed unnecessary by the DVB group because its benefits did not justify the extra receiver complexity. Finally, the modulation system combines OFDM with QPSK/QAM. OFDM uses a large number of carriers that spread the information content of the signal. Used successfully in DAB (digital audio broadcasting), the major advantage of OFDM is multi-path resistance.

Improved multi-path immunity is obtained through the use of a guard interval, a portion of the digital signal given away for echo resistance. This guard interval reduces the transmission capacity of OFDM systems. However, the greater the number of OFDM carriers provided, for a given maximum echo time delay, the less transmission capacity is lost. Nonetheless, a tradeoff is involved. Simply increasing the number of carriers has a significantly detrimental impact on receiver complexity and phase-noise sensitivity.

Because of the multi-path immunity of OFDM, it may be possible to operate an overlapping network of transmitting stations with a single frequency. In the areas of overlap, the weaker of the two received signals is similar to an echo signal. However, if the two transmitters are far apart, causing a large time delay between the two signals, the system will require a large guard interval.

The potential exists for three different operating environments for digital terrestrial television in Europe, including broadcast on a currently unused channel, such as an adjacent channel, or on a clear channel; broadcast in a small-area single-frequency network (SFN); or broadcast in a large-area SFN.

One of the main challenges for the DVB-T developers is that the different operating environments lead to somewhat different optimum OFDM systems. The common 2k/8k specification has been developed to offer solutions for all (or nearly all) operating environments.

It should be noted that, in the DVB-T system, the ratio of guard interval Tg over the desired symbol interval Tu may be 1/32, 1/16, 1/8 and 1/4, and Tu is respectively 2048 and 8192 in the 2K-mode and 8K-mode transmission. Thus, in order to recover the original information carried in an OFDM signal received from an OFDM transmitter, the values of Tu and Tg must be known before implementing guard interval removal and discrete Fourier transform. A mode detection mechanism is required in the DVB-T receiver.

In U.S. Pat. No. 6,330,293, Otto Klank et al. disclose a mode detection method. At the receiver end, coarse time synchronization linked to mode detection and, possibly and additionally, coarse AFC (automatic frequency correction) are carried out initially both for seeking and identifying received signals, as well as for continuously monitoring them. The time signal is correlated with the time signal shifted by the desired symbol length Tu. This correlation may be carried out more than once, for example five times per data frame. In this correlation, signal samples of different length Tu are used, depending on the respective mode, and the correlation result maximum obtained from this are then used to deduce the present mode (for example 2K or 8K modes). If no usable correlation result maximum is obtained, the correlation steps may be repeated.

FIG. 2 is a diagram showing a mode detector disclosed in U.S. patent application publication No. 2002/0186791. The I and Q samples of the received signal are supplied to an input terminal 10. The samples are supplied to a 2k and 8k size first-in first-out (FIFO) memory 121 and 122. The moving average correlation of the samples over a minimum guard period is then calculated in blocks 141 and 142, and the power of the correlation measured in blocks 161 and 162. The correlation function is calculated in blocks 141 and 142 by multiplying input symbols with symbols contemporaneously obtained from the delay blocks 121 and 122 with the delay applied thereto, thereby obtaining a measure of the correlation between them. The results are then summed, and a running average is calculated over a number of samples, equal to the smallest allowed guard interval size, that is, 1/32 of the FFT size. Thus, for example, g=64 and 256 samples in 2k and 8k mode respectively. Each combination of the blocks 141 and 161, and 142 and 162 therefore forms a correlation function, and the separation between peaks in each correlation function depends on the total duration of the symbol plus the guard period. The resulting measurements are passed to blocks 181 and 182 for decimation (i.e., removal of some portion of the samples). The samples remaining after decimation in blocks 181 and 182 are then passed through filtering resonators 191-198, each centered at a respective resonance frequency based on the COFDM symbol frequency of a particular combination of the mode and the guard interval. A counter (not shown) is provided at the output of each of the resonators 191-198, and each counter increments when its peak power is largest. The peak powers produced by each resonator are then compared. Thus, by examining the counter values after a number of symbols, the counter with the highest value is determined to be that which corresponds to the mode (either 2k or 8k) and guard period used by the transmitted signal.

However, the mode detection using only correlation result maxima or power peak is susceptible to noise. Multi-path propagation reduces the correlation result maxima or power peak, and makes it indistinct. Thus, no usable correlation result maxima or power peak will be obtained or detected if the RF signal is received through multi-path propagation.

### SUMMARY OF THE INVENTION

The object of the present invention is to provide an efficient method and apparatus of mode detection for OFDM signals in a DVB-T receiver.

The present invention provides a method for processing a RF OFDM signal transmitted from an OFDM transmitter. The method comprises the steps of receiving and converting the RF OFDM signal into an IF OFDM signal, converting the IF OFDM signal into a digital OFDM signal, detecting a transmission mode and guard interval length of the OFDM signal, implementing digital processing of the OFDM signal in time domain and frequency domain, and implementing channel decoding and de-interleaving of the OFDM signal, wherein the mode detection comprises the steps of a) selecting one of the desired symbol lengths, b) selecting one of threshold values, c) generating a correlation power signal of the digital OFDM signal using the desired symbol lengths, d) detecting edges of the correlation power signal using the selected threshold value, e) when the edge detection succeeds, determining the transmission mode and guard interval length by the detected edges, and f) when the edge detection fails, determining whether all the threshold values have been selected, if so, selecting another one of the desired symbol lengths and repeating steps b, c, d, e and f, otherwise, selecting another one of the threshold values and repeating steps c, d, e and f.

The present invention also provides an OFDM receiver comprising a front end receiving and converting the RF OFDM signal into an IF OFDM signal, an A/D converter converting the IF OFDM signal into a digital OFDM signal, a mode detector detecting a transmission mode and guard interval length of the digital OFDM signal, frequency and time domain digital processors implementing digital processing of the OFDM signal in time domain and frequency domain, and a channel decoder and de-interleaver implementing channel decoding and de-interleaving of the OFDM signal, wherein the mode detector implements the steps of a) selecting one of the desired symbol lengths, b) selecting one of the threshold values, c) generating a correlation power signal of the OFDM signal using the desired symbol lengths, d) detecting edges of the correlation power signal using the selected threshold value, e) when the edge detection succeeds, determining the transmission mode and guard interval length by the detected edges, and f) when the edge detection fails, determining whether all the threshold values have been selected, if so, selecting another one of the desired symbol lengths and repeating steps b, c, d, e and f, otherwise, selecting another one of the threshold values and repeating steps c, d, e and f.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a diagram showing power spectral density of the OFDM signal.

FIG. 2 is a diagram showing a conventional mode detector.

FIG. 3 is a functional block diagram of an OFDM receiver according to one embodiment of the invention.

FIG. 4A-4D are diagrams showing general power curves of correlation derived by the correlation circuit according to one embodiment of the invention.

FIG. 5 is a flowchart of a mode detection method implemented by the mode detector according to one embodiment of the invention.

FIG. 6 is a flowchart showing the detailed search steps for 2K or 8k mode according to one embodiment of the invention.

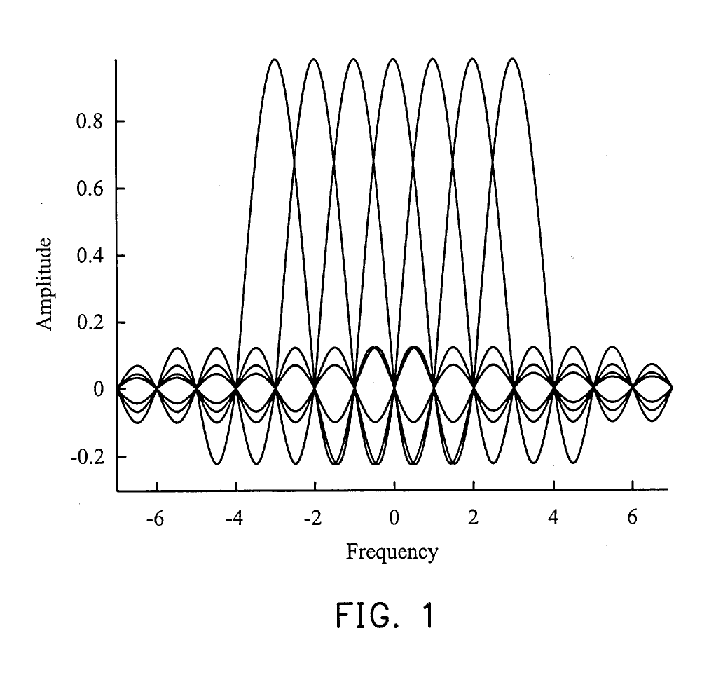

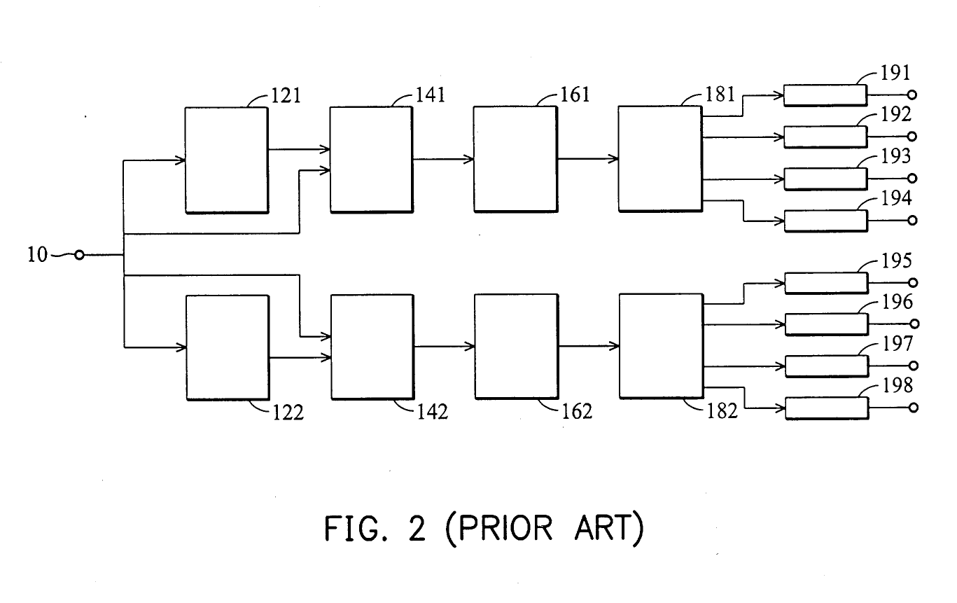

### DETAILED DESCRIPTION OF THE INVENTION

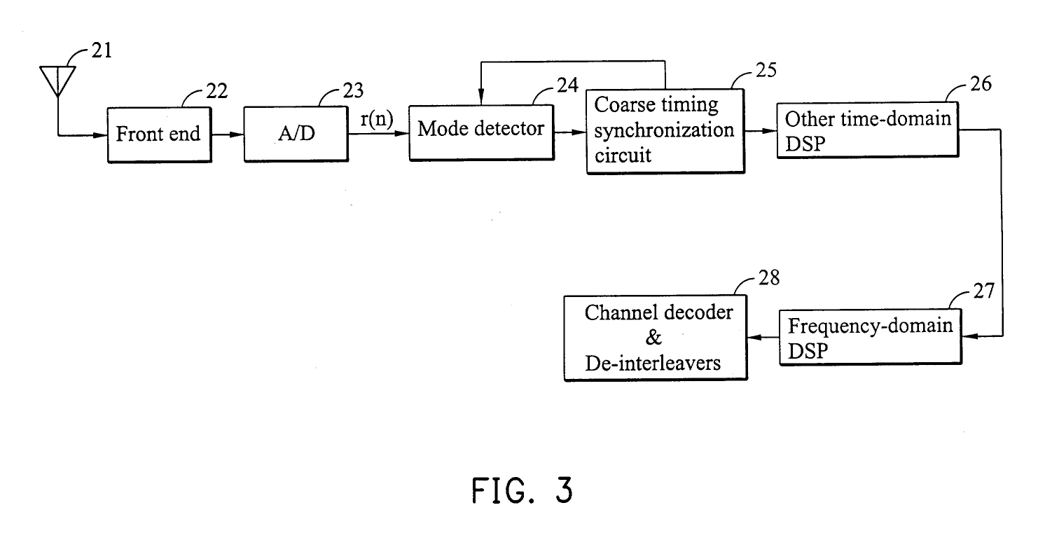

FIG. 3 is a functional block diagram of an OFDM receiver according to one embodiment of the invention. The OFDM receiver 2 includes an antenna 21, a front end 22, A/D converter 23, mode detector 24, coarse timing synchronization circuit 25, other time-domain digital signal processor 26, frequency-domain digital signal processor 27 and channel decoder and de-inter-leaver 28.

The antenna 21 receives a radio frequency (RF) signal from an OFDM transmitter (not shown). The RF signal received by the antenna 21 is an OFDM modulated signal carrying OFDM symbols. The OFDM receiver 2 performs a receiving process for the OFDM symbols.

The front end 22 typically includes an RF tuner converting the received RF signal in frequency to an intermediate frequency band (IF) signal, amplifying it, and applying it to the A/D converter 23.

The digital signal r(n) from the A/D converter 23 is sent to the mode detector 24 having a correlation circuit 241 and an edge detector 242 for detection of the transmission mode of the OFDM signal. The mode detector 24 will be described in detail later.

After the mode detection, the digital OFDM signal is digitally processed in time-domain. For the sake of clarity, a coarse timing synchronization circuit 25 is shown separately from another time-domain digital processor 26. Thus, the digital OFDM signal from the mode detector 24 is coarsely synchronized at first and then sent to the processor 26 for other time-domain digital processing.

Through the time and frequency domain processor 26 and 27, the OFDM signal is mixed down to baseband signal, finely synchronized, with cyclic prefix removed, FFT applied to, and the channels being estimated and equalized. The cyclic prefix removal, synchronization and channel estimation are explained in the following.

The cyclic prefix in the OFDM signal is removed before implementation of FFT. The cyclic prefix is used to completely eliminate the inter-symbolic interference. A guard time larger than the expected delay spread is chosen such that multi-path components from one symbol cannot interfere with the next symbol, wherein the cyclic prefix is located. This guard time may be no signal at all, in which case the problem of inter-carrier interference (ICI) arises. Then, the OFDM symbol is cyclically extended in the guard time. Using this method, the delay replicas of the OFDM symbol always have an integer number of cycles within the FFT interval, as long as the delay is smaller than the guard time. Multi-path signals with delays smaller than the guard time cannot cause ICI.

Synchronization is a major hurdle in achieving OFDM. Synchronization usually consists of three parts:

1. Frame detection

2. Carrier frequency offset estimation and correction

3. Sampling error correction

Frame detection determines the symbol boundary so that correct samples for a symbol frame can be taken. Due to the carrier frequency difference between the transmitter and receiver, each signal sample at time t contains an unknown phase factor where Δfc is the unknown carrier frequency offset. This unknown phase factor must be estimated and compensated for each sample before FFT at the receiver since otherwise the orthogonality between sub-carriers is lost. For example, when the carrier is at 5 GHz, a 100 ppm crystal offset corresponds to a frequency offset of 50 kHz. For a symbol period of T=3.2 μs, Δfc T=1.6.

The synchronized signal after FFT is input to a channel estimator. The channel estimation is performed by inserting pilot tones into each OFDM symbol. The first one, block type pilot channel estimation, has been developed under the assumption of slow fading channel. Even with a decision feedback equalizer, this assumes that the channel transfer function is not changing very rapidly. The estimation of the channel for this block-type pilot arrangement can be based on Least Square (LS) or Minimum Mean-Square (MMSE). The MMSE estimate has been shown to give a 10-15 dB gain in signal-to-noise ratio (SNR) for the same mean square error of channel estimation over the LS estimate. The second, the comb-type pilot channel estimation, has been introduced to satisfy the need for equalizing when the channel changes from even one OFDM block to the subsequent one. The comb-type pilot channel estimation consists of algorithms to estimate the channel at pilot frequencies and to interpolate the channel.

After the digital processors 26 and 27, the OFDM signal is sent to the channel decoder and de-interleaver 28. In a DVB-T transmitter, the generation of the OFDM signal includes steps of transport multiplex adaptation and randomization for energy dispersal, outer coding and outer interleaving, inner coding, inner interleaving, and signal constellations and mapping. Thus, at the receiver end, in order to recover the OFDM signal, corresponding inverse steps must be implemented by the channel decoder and de-interleaver 28.

Finally, the data, such as MPEG-2 data, carried on the OFDM signal is derived.

The mode detector 24 will be described in the following.

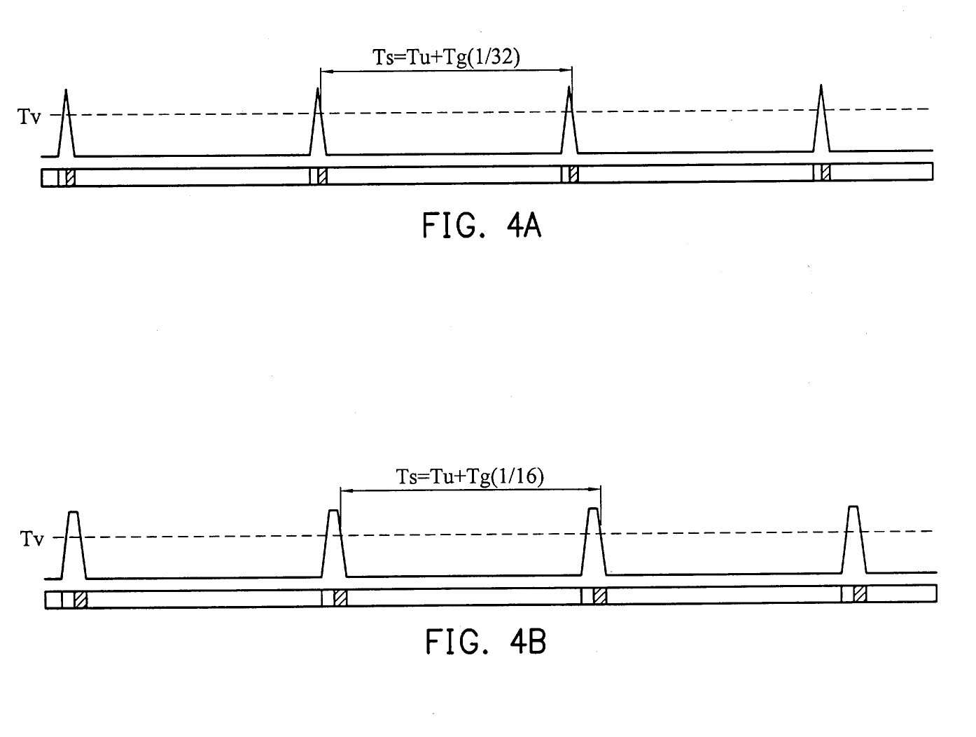

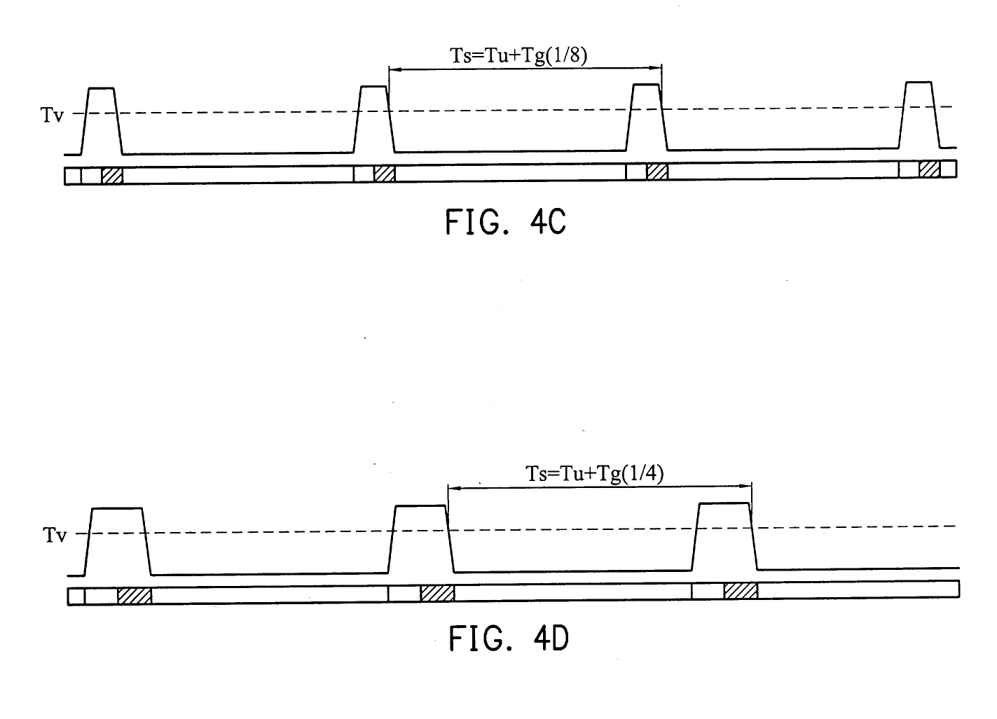

Design of the mode detector 24 is based on the concepts of correlation and edge detection. The applicability of correlation method comes from the fact that the GI part in each time-domain OFDM symbol is the copy of the rear portion of the desired part of the same OFDM symbol. Therefore, when the whole GI is correlated with the rear portion of the desired part, from which the GI is copied, the maximum correlation result (in the signal power sense) will, i.e., a power peak appears. In this embodiment, only two GI lengths of 64 and 256 are used by the correlation circuit 241 to perform correlation operations of 2K and 8K mode detection although there are many other possible GI lengths. Thus, clear correlation peaks will not appear at the output of the correlation circuit 241 unless the target GI length happens to be the least GI length (64 for 2K mode and 256 for 8K mode). FIG. 4A˜4D are diagrams showing general power curves of correlation derived by the correlation circuit 241 using the four possible GI lengths. It is noted that, instead of periodic peaks, periodic plateaus appear for correlation with Tg=1/4, 1/8 and 1/16. The interval Ts between two plateaus equals the sum of the FFT size (mode) Tu and the target GI length Tg. Due to the periodic occurrence of correlation plateaus, the necessity for the edge detector 241 naturally arises to detect the target GI length. Of course, the application of the edge detector 242 requires a threshold value Tv, as is shown in FIG. 4A˜4D.

Under multi-path propagation environments, the energy dispersion of the received signal will normally decrease the height of the correlation power plateaus. In these cases, a smaller Tv than that used in normal cases (AWGN channels, for instance) will achieve better performance for the edge detector. On the other hand, when a small Tv is used under some channels such as an AWGN channel, the probability of detection error will increase. For the edge detector 242 to work properly under various channel conditions, a set of multiple threshold values ordered from high to low is adopted.

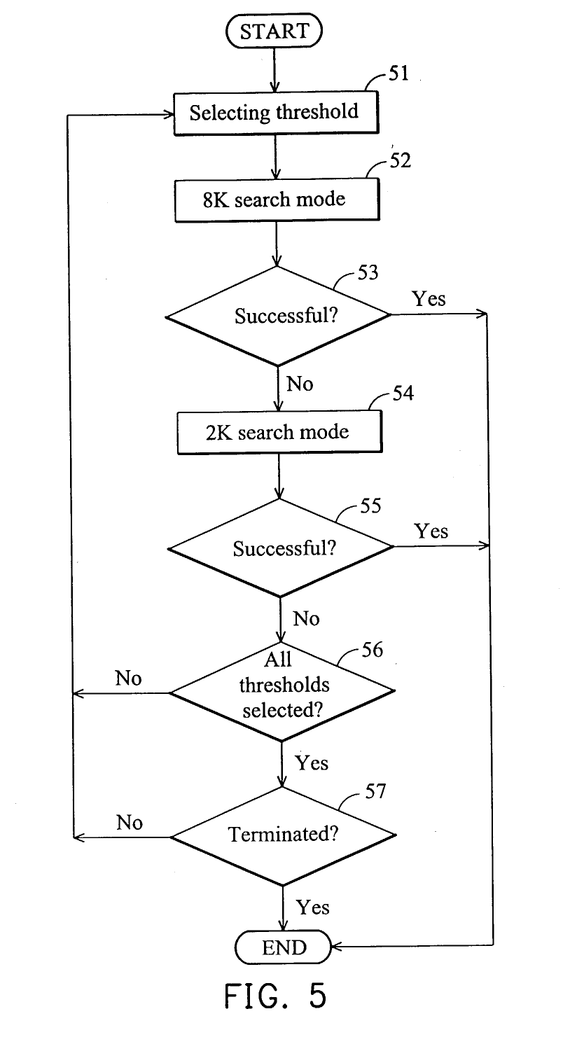

FIG. 5 is a flowchart of a mode detection method implemented by the mode detector 24. The mode detector 24 is activated by an activating signal from the system control or the coarse timing synchronization circuit 25.

In step 51, a threshold Tv is selected for the edge detector 242. For the first round, the largest in the set of values Tv is selected.

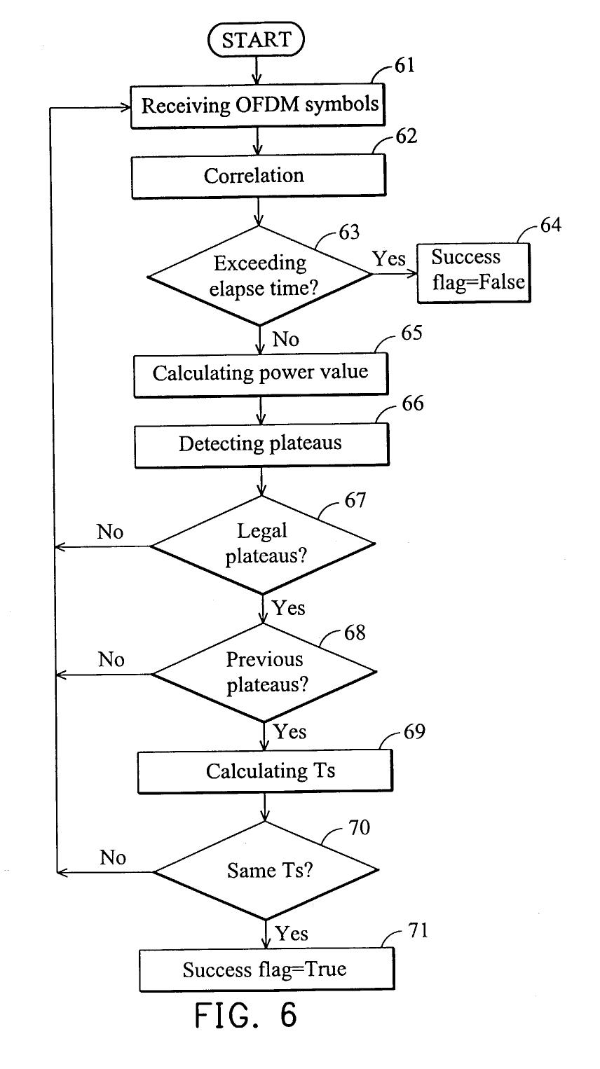

In step 52, the mode detector 24 performs the target GI length search for the 8K mode (the detailed search steps are shown in FIG. 6, which will be explained later).

In step 53, the mode detection is completed if the target GI length is successfully detected and acknowledged by the coarse timing synchronization circuit 25; otherwise, the flow proceeds to step 54.

In step 54, the mode detector 24 enters into the 2K mode searching for the target GI length with the same Tv for the edge detector 242.

In step 55, the mode detection is completed if the target GI length is successfully detected and acknowledged by the coarse timing synchronization circuit 25; otherwise, the flow proceeds to step 56.

In step 56, it is determined whether all the threshold values Tv have been selected. If so, the flow proceeds to step 57; otherwise, the flow returns to step 51 for a next search round, wherein a new and smaller Tv value is selected.

In step 57, the system control determines whether the mode detection should be stopped (because the search time is up or a limited number of search rounds are reached). If so, the mode detection probably fails because there is no received OFDM signal; otherwise, the flow returns to step 51 and restarts mode detection, wherein the largest Tv values is selected again.

It should be noted that the coarse timing synchronization circuit 25 roughly determines the beginning of the desired part of an OFDM symbol. It utilizes correlation and peak detection to locate the beginning of the desired part. This requires the actual FFT size Tu and GI length. If the mode detector 24 provides the wrong Tu and Tg, the resulted correlation power curves in the coarse timing synchronization circuit 25 will not yield clear peaks at the actual beginning of the desired parts. Therefore, the coarse timing synchronization circuit 25 further checks the correctness of the detected parameters from the mode detector 24. If the detected parameters from the mode detector 24 are incorrect, the coarse timing synchronization circuit 25 will assert the activating signal to re-activate the mode detector 24.

FIG. 6 is a flowchart showing the detailed search steps for 2K or 8k mode.

In step 61, the OFDM symbols are received by the correlation circuit 241.

In step 62, the data correlation c(n) is calculated by the correlation circuit 242 according to the following equation:

C(n)=c(n−1)+p(n)−p(n−Tg, min),

Where the complex product term

P(n)=x(n)x*(n−Tu), and Tu is 2048 when the current search mode is 2K, or 8192 in 8K search mode. X(n) is the normalized input signal and is expressed as

X(n)=r(n)/sqrt(Tg, min)

(Tg, min) means the least (minimum) GI length, and is 64 for the 2K search mode and 256 for the 8K search mode. The goal of performing the normalization operation is for the selected Tv to be applicable universally in both 2K and 8K search modes.

In step 63, it is determined by the system control whether the search exceeds the elapsed time. If so, the flow proceeds to step 64; otherwise, the flow proceeds to step 65.

In step 64, a success flag is set to false and the other search mode (2K or 8k) is implemented.

In step 65, after the correlation is derived, its power value |c(n)|₂ is calculated by the correlation circuit 241.

In step 66, the edge detector 242 detects a plateau in the power signal |c(n)|₂.

In step 67, it is determined whether the detected plateau is legal, i.e., a plateau with a width (the interval between a rising edge and its accompanying falling edge in the power signal |c(n)|₂) larger than a predetermined threshold. If so, the flow proceeds to step 68; otherwise, the flow returns to step 61.

In step 68, it is determined whether a legal plateau has been detected previously to the current legal plateau. If so, the flow proceeds to step 69; otherwise, the flow returns to step 61 to search for the next legal plateaus.

In step 69, the interval Ts_est between two plateaus is measured and quantized to the nearest nominal Ts. Since Ts=Tu+Tg, from the quantized Ts, the detector derives the target GI length.

In step 70, it is determined whether the same Ts is detected for M consecutive times, where M is a predetermined number. If so, the flow proceeds to step 71; otherwise, the flow returns to step 61.

In step 71, the success flag is set to true, and the detected Tu and Tg are output to the coarse synchronization circuit 25.

In conclusion, the present invention provides a method and apparatus for detecting the transmitted mode and guard-interval length of the received OFDM signals by applying the concepts of correlation and edge detection. The two modes of the DVB-T system are sequentially searched. Within each mode, by detecting the falling edges of legal peaks and examining the interval between two falling edges of amplitude values of the correlation results, the guard-interval length adopted by the transmitter is determined. Multiple threshold values for the edge detection increase the probability of successful detection under various kinds of communication channels. Feedback signal from the coarse timing synchronization module ensure the correctness of the detected results.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for processing a RF OFDM signal transmitted from an OFDM transmitter, comprising the steps of:
receiving and converting the RF OFDM signal into an IF OFDM signal;
converting the IF OFDM signal into a digital OFDM signal;
detecting a transmission mode and guard interval length of the OFDM signal, comprising steps of:
a) selecting one of the desired symbol lengths;
b) selecting one of the threshold values;
c) generating a correlation power signal of the digital OFDM signal using the selected desired symbol length;
d) detecting edges of the correlation power signal using the selected threshold value;
e) when the edge detection succeeds, determining the transmission mode and guard interval length by the detected edges; and
f) when the edge detection fails, determining whether all the threshold values have been selected, if so, selecting another one of the desired symbol lengths and repeating steps b, c, d, e and f, otherwise, selecting another one of the threshold values and repeating steps c, d, e and f;
implementing digital processing of the OFDM signal in time domain and frequency domain; and
implementing channel decoding and de-interleaving of the OFDM signal.

2. The method as claimed in claim 1, wherein there are two desired symbol lengths to be selected, which are 2048 for a 2K transmission mode and 8192 for an 8K transmission mode.

3. The method as claimed in claim 1, wherein the threshold values are selected sequentially from large to small.

4. The method as claimed in claim 1, wherein the mode detection succeeds when widths of at least two plateaus in the correlation power signal are derived by the detected edges and both are larger than a predetermined second threshold, and at least two symbol lengths derived by the detected edges are the same.

5. A method of mode detection for an OFDM signal comprising the steps of:
a) selecting one of the desired symbol lengths;
b) selecting one of the threshold values;
c) generating a correlation power signal of the OFDM signal using the selected desired symbol length;
d) detecting edges of the correlation power signal using the selected threshold value;
e) when the edge detection succeeds, determining the transmission mode and guard interval length by the detected edges; and
f) when the edge detection fails, determining whether all the threshold values have been selected, if so, selecting another one of the desired symbol lengths and repeating steps b, c, d, e and f, otherwise, selecting another one of the threshold values and repeating steps c, d, e and f.

6. The method as claimed in claim 5, wherein there are two desired symbol lengths to be selected, which are 2048 for a 2K transmission mode and 8192 for an 8K transmission mode.

7. The method as claimed in claim 5, wherein the threshold values are selected sequentially from large to small.

8. The method as claimed in claim 5, wherein the mode detection succeeds when widths of at least two plateaus in the correlation power signal are derived by the detected edges and both are larger than a predetermined second threshold, and at least two symbol lengths derived by the detected edges are the same.

9. An OFDM receiver comprising:
a front end receiving and converting the RF OFDM signal into an IF OFDM signal;
an A/D converter converting the IF OFDM signal into a digital OFDM signal;
a mode detector detecting a transmission mode and guard interval length of the digital OFDM signal by the steps of:
a) selecting one of the desired symbol lengths;
b) selecting one of the threshold values;
c) generating a correlation power signal of the OFDM signal using the selected desired symbol length;
d) detecting edges of the correlation power signal using the selected threshold value;
e) when the edge detection succeeds, determining the transmission mode and guard interval length by the detected edges; and
f) when the edge detection fails, determining whether all the threshold values have been selected, if so, selecting another one of the desired symbol lengths and repeating steps b, c, d, e and f, otherwise, selecting another one of the threshold values and repeating steps c, d, e and f;
frequency and time domain digital processors implementing digital processing of the OFDM signal in time domain and frequency domain; and
a channel decoder and de-interleaver implementing channel decoding and de-interleaving of the OFDM signal.

10. The OFDM receiver as claimed in claim 9, wherein there are two desired symbol lengths to be selected, which are 2048 for a 2K transmission mode and 8192 for an 8K transmission mode.

11. The OFDM receiver as claimed in claim 9, wherein the threshold values are selected sequentially from large to small.

12. The OFDM receiver as claimed in claim 9, wherein the mode detection succeeds when widths of at least two plateaus in the correlation power signal are derived by the detected edges and both are larger than a predetermined second threshold, and at least two symbol lengths derived by the detected edges are the same.

13. A mode detector detecting a transmission mode and guard interval length of the digital OFDM signal by the steps of:
a) selecting one of the desired symbol lengths;
b) selecting one of the threshold values;
c) generating a correlation power signal of the OFDM signal using the selected desired symbol length;
d) detecting edges of the correlation power signal using the selected threshold value;
e) when the edge detection succeeds, determining the transmission mode and guard interval length by the detected edges; and
f) when the edge detection fails, determining whether all the threshold values have been selected, if so, selecting another one of the desired symbol lengths and repeating steps b, c, d, e and f, otherwise, selecting another one of the threshold values and repeating steps c, d, e and f.

14. The mode detector as claimed in claim 13, wherein there are two desired symbol lengths to be selected, which are 2048 for a 2K transmission mode and 8192 for an 8K transmission mode.

15. The mode detector as claimed in claim 13, wherein the threshold values are selected sequentially from large to small.

16. The mode detector as claimed in claim 13, wherein the mode detection succeeds when widths of at least two plateaus in the correlation power signal are derived by the detected edges and both larger than a predetermined second threshold, and at least two symbol lengths derived by the detected edges are the same.
